(19) United States
(12) Patent Application Publication
(10) Pub. No.: US 2007/0174689 A1
(43) Pub. Date: Jul. 26, 2007

(54) Computer platform embedded operating system backup switching handling method and system

(75) Inventor: Chih-Wei Chen, Taipei (TW)

Correspondence Address: FULBRIGHT AND JAWORSKI LLP, 555 S. FLOWER STREET, 41ST FLOOR, LOS ANGELES, CA, 90071, US

(73) Assignee: INVENTEC CORPORATION

(21) Appl. No.: 11/391,797

(22) Filed: Mar. 28, 2006

(30) Foreign Application Priority Data
Nov. 23, 2005 (TW) 94141075

(51) Int. Cl. G06F 11/00

(52) U.S. Cl. 714/13

(57) ABSTRACT

A computer platform embedded operating system backup switching handling method and system is proposed, which is designed for use with a computer platform for providing an embedded operating system backup switching handling function, and which is characterized by the provision of an operating system health status flag for indicating whether the embedded operating system code has been previously successfully loaded, such that the next time the computer platform is started, the operating system health status flag can be checked to see if the embedded operating system code is corrupted; if YES, a backup copy of operating system code is used for booting. This feature allows the computer platform to more quickly judge whether the embedded operating system code is corrupted, without having to use the more time-wasting checksum method, so that the booting of the computer platform can be more efficiently carried out.

### BACKGROUND OF THE INVENTION

1. Field of the Invention

This invention relates to information technology (IT), and more particularly, to a computer platform embedded operating system backup switching handling method and system which is designed for use in conjunction with a computer platform of the type having a non-volatile memory unit (such as a flash memory unit) for storing multiple copies of an embedded operating system, including one primary copy and at least one backup copy, for the purpose of providing an embedded operating system backup switching handling function that can be activated in the event of a failure to the primary copy of the embedded operating system code to switch the computer platform to operate under a backup copy of the embedded operating system code.

2. Description of Related Art

In computer technology, operating systems are used to control the operations of computer platforms. Traditionally, the code of an operating system is preloaded into a hard disk of a computer platform such that at the startup of the computer platform, the operating system code can be loaded from the hard disk into the computer platform's primary memory. This process is customarily called booting and typically controlled by BIOS (Basic Input/Output System). After the operating system code is successfully loaded, the computer platform can then function normally to allow the user to run application programs.

With the advances in computer technology, many small-scale computer platforms nowadays, such as portable computers, palmtop computers, intelligent mobile phones, to name just a few, utilize flash memory as the storage device for operating system code. This type of operating system is customarily referred to as “embedded operating system”. Moreover, in order to assure the operability operating system, two copies of the same operating system code are typically stored in the flash memory, one being used as a primary copy and the other as a backup copy. Normally, the primary copy of operating system code is initially used to run the computer platform; and in the event of a failure to the primary copy of the embedded operating system code, the backup copy is used instead to run the computer platform.

During the booting process, the BIOS will first retrieve the embedded operating system code from the flash memory, and then perform an error checking procedure on the retrieved code before loading it into the primary memory to check whether the embedded operating system code is corrupted. A conventional error checking method is the checksum method. If the checksum method determines that the embedded operating system code is erroneous, then the BIOS will switch the loading channel to the backup copy of the operating system code to boot the computer platform.

One drawback to the use of checksum method for error checking of embedded operating system code, however, is that the content of the operating system code is not fixed but dynamically changing during operation, i.e., new data or settings will be produced during runtime and which must be added to the operating system code and permanently stored into the flash memory. Consequently, the checksum value of retrieved operating system code from the flash memory would be also dynamically changing without having a fixed value. For this sake, each time the operating system code is retrieved, the BIOS needs to perform a checksum computation procedure, which would undesirably waste extra time and more system resource for the computation. If the amount of operating system code is doubled, for example from 32 MB (megabyte) to 64 MB, then the checksum computation time would also be doubled. The conventional method for error checking of operating system code is therefore quite time-consuming and highly inefficient.

### SUMMARY OF THE INVENTION

It is therefore an objective of this invention to provide a computer platform embedded operating system backup switching handling method and system which allows the BIOS to be able to more efficiently judge whether the embedded operating system code is corrupted, so as to allow the booting of the computer platform

The computer platform embedded operating system backup switching handling method and system according to the invention is designed for use in conjunction with a computer platform of the type having a non-volatile memory unit (such as a flash memory unit) for storing multiple copies of an embedded operating system, including one primary copy and at least one backup copy, for the purpose of providing the computer platform with an embedded operating system backup switching handling function that can be activated in the event of a failure to the primary copy of the operating system code to switch the computer platform to operate under the backup copy of the operating system code.

The computer platform embedded operating system backup switching handling method according to the invention comprises: (1) in the event of the operating system code stored in the primary operating system code storage area is successfully loaded into the computer platform, responding by inspecting whether the loaded operating system code can operate normally; if YES, setting an operating system health status flag to a normal operation indicating value; (2) responding to each startup event on the computer platform by checking the current setting of the operating system health status flag; if the operating system health status flag is currently set to a normal operation indicating value, then issuing a primary operating system code loading enable message, and setting the operating system health status flag to an normal operation indicating value; whereas if currently set to a abnormal operation indicating value, issuing an operating system loading channel switching enable message; and (3) responding to the operating system loading channel switching enable message by switching the current operating system loading channel from the primary operating system code storage area to the backup operating system code storage area to thereby allow the computer platform to perform a booting procedure with the operating system code stored in the backup operating system code storage area; and further setting the primary operating system loading channel failure flag to true value, and in the event of a failure to the backup operating system code storage area, setting the backup operating system loading channel failure flag to true value.

In architecture, the computer platform embedded operating system backup switching handling system is based on an object-oriented component model which comprises: (a) a startup control module, which is capable of responding to each startup event on the computer platform to perform a startup control procedure, and which is provided with an operating system health status flag, a primary operating system loading channel failure flag, and a backup operating system loading channel failure flag; (b) an operating system health inspection module, which is integrated to the code of the operating system of the computer platform, and which is capable of being activated in response to each successful booting of the computer platform with the operating system code stored in the primary operating system code storage area to check whether the loaded operating system code is able to operate normally; and if YES, capable of setting the operating system health status flag to a normal operation indicating value, where the normal operation indicating value is used by the startup control module to judge whether the previous startup of the computer platform was successful; and wherein after the startup control module judges that the operating system health status flag is set at normal operation indicating value, the startup control module resets the operating system health status flag to an abnormal operation indicating value, such that at the next startup of the computer platform, if the operating system health status flag is set at abnormal operation indicating value, the startup control module issues an operating system loading channel switching enable message; and (c) an operating system loading channel switching module, which is capable of responding to the operating system loading channel switching enable message from the startup control module by switching the current operating system loading channel from the primary operating system code storage area to the backup operating system code storage area to thereby allow the startup control module to perform a backup operating system code loading procedure; and which is further capable of setting the primary operating system loading channel failure flag to true value, and in the event of a failure to the backup operating system code storage area, setting the backup operating system loading channel failure flag to true value.

The computer platform embedded operating system backup switching handling method and system according to the invention is characterized by the provision of an operating system health status flag for indicating whether the primary copy of embedded operating system code has been previously successfully loaded, such that the next time the computer platform is started, the operating system health status flag can be checked to see if the primary copy of embedded operating system code is corrupted; if YES, the booting of the computer platform is switched to use the backup copy of the embedded operating system code. This feature allows the computer platform to more quickly judge whether the embedded operating system code is corrupted, without having to use the more time-wasting checksum method, so that the booting of the computer platform can be more efficiently carried out.

### BRIEF DESCRIPTION OF DRAWINGS

The invention can be more fully understood by reading the following detailed description of the preferred embodiments, with reference made to the accompanying drawings, wherein:

FIG. 1 is a schematic diagram showing the application and object-oriented component model of the computer platform embedded operating system backup switching handling system according to the invention.

### DETAILED DESCRIPTION OF PREFERRED EMBODIMENTS

The computer platform embedded operating system backup switching handling method and system according to the invention is disclosed in full details by way of preferred embodiments in the following with reference to the accompanying drawings.

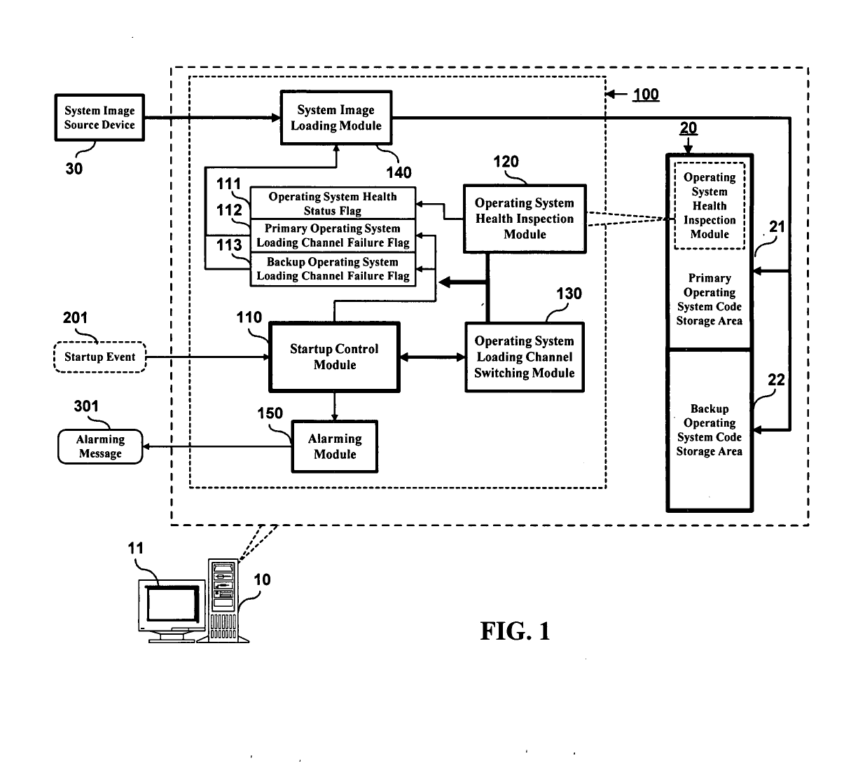

FIG. 1 is a schematic diagram showing the application and object-oriented component model of the computer platform embedded operating system backup switching handling system according to the invention (as the part enclosed in the dotted box indicated by the reference numeral 100). As shown, the computer platform embedded operating system backup switching handling system of the invention 100 is designed for use in conjunction with a computer platform 10, such as a desktop computer, a notebook computer, or a network server, that is equipped with a non-volatile memory unit 20 (such as a flash memory unit) which is partitioned into at least two operating system code storage areas, including a primary operating system code storage area 21 and a backup operating system code storage area 22 for storing at least two copies of an operating system. In actual operation,, the computer platform embedded operating system backup switching handling system of the invention 100 is capable of providing the computer platform 10 with an embedded operating system backup switching handling function that can be activated in the event of a failure to the primary operating system code storage area 21 to switch the computer platform 10 to operate under the backup copy of the operating system code stored in the backup operating system code storage area 22.

As shown in FIG. 1, in architecture, the computer platform embedded operating system backup switching handling system of the invention 100 is based on an object-oriented component model which comprises: (a) a startup control module 110; (b) an operating system health inspection module 120; and (c) an operating system loading channel switching module 130; and can further optionally comprise a system image loading module 140 and an alarming module 150. In practical implementation, the operating system health inspection module 120 and the system image loading module 140 are realized by software-based computer code and integrated as an add-on module to the operating system of the computer platform 10, while the startup control module 110 and the operating system loading channel switching module 130 are realized by firmware-based computer code and integrated to the BIOS (Basic Input/Output System) of the computer platform 10.

Firstly, the respective attributes and behaviors of the constituent modules 110, 120, 130,140, 150 of the computer platform embedded operating system backup switching handling system of the invention 100 are described in details in the following

The startup control module 110 is designed for integration to the BIOS of the computer platform 10, and which is capable of responding to each startup event 201 on the computer platform 10 to thereupon perform a startup control procedure. Internally, the startup control module 110 is provided with an operating system health status flag 111, a primary operating system loading channel failure flag 112, and a backup operating system loading channel failure flag 113. It is to be noted that the provision of the channel failure flags 112, 113 is dependent on the number of channels that can be used to load the operating system during booting. During the booting procedure, the startup control module 110 will inspect the current settings (i.e., TRUE or FALSE) of the operating system health status flag 11 1, the primary operating system loading channel failure flag 112, and the backup operating system loading channel failure flag 113 to accordingly perform corresponding control actions to the computer platform 10. Furthermore, when the startup control module 1 10 completes a POST (Power On Self Test) procedure, it will set the operating system health status flag 111 to an abnormal operation indicating value (i.e., FALSE value).

The operating system health inspection module 120 is integrated to the operating system of the computer platform 10, and which is capable of being activated in response to each successful booting of the computer platform 10 with the operating system code stored in the primary operating system code storage area 21 to check whether the loaded operating system code is able to operate normally. If YES, the operating system health inspection module 120 capable of setting the operating system health status flag 111 from an normal operation indicating value (i.e., FALSE value) to a normal operation indicating value (i.e., TRUE value), where the normal operation indicating value is used by the startup control module 110 to judge whether the previous startup of the computer platform 10 was successful. After the startup control module 110 judges that the operating system health status flag 111 is set at normal operation indicating value (TRUE), the startup control module 110 will reset the operating system health status flag 111 to an abnormal operation indicating value (FALSE), such that at the next startup of the computer platform, if the operating system health status flag 111 is set at abnormal operation indicating value (FALSE), the startup control module 110 issues an operating system loading channel switching enable message to request for a loading channel switching action; otherwise, if the operating system health status flag 111 is set at normal operation indicating value (TRUE), the loading channel switching action is unnecessary. In practical implementation, the operating system health inspection module 120 is integrated to the operating system of the computer platform 10, and therefore will be executed only when the operating system code stored in the primary operating system code storage area 21 is successfully loaded and operates normally on the computer platform 10 to thereupon set the operating system health status flag 111 to a normal operation indicating value (TRUE). Further, during the POST procedure, if the startup control module 110 checks that the operating system health status flag 111 is set at [FALSE] value, indicating that the previous attempt to start up the computer platform 10 is a failure, the startup control module 110 will find the loading channel that is associated with the failed operating system code and set its loading channel failure flag to [TRUE]; i.e., during the POST procedure performed by the startup control module 110, the startup control module 110 can respond to the event of the operating system health status flag 111 being set at [FALSE] value to check the primary operating system loading channel failure flag 112 and the backup operating system loading channel failure flag 113 to determine whether the primary operating system loading channel or the backup operating system loading channel is in failed condition, and if YES, will initiate a loading channel switching action.

The operating system loading channel switching module 130 is designed to respond to the operating system loading channel switching enable message from the startup control module 110 by switching the current operating system loading channel from the primary operating system code storage area 21 to the backup operating system code storage area 22 to thereby allow the startup control module 110 to perform a backup operating system code loading procedure; and which is further capable of setting the primary operating system loading channel failure flag 112 to [TRUE] value, and in the event of a failure to the backup operating system code storage area 22, setting the backup operating system loading channel failure flag 113 to [TRUE] value. In practical implementation, the primary operating system loading channel failure flag 112 and the backup operating system loading channel failure flag 113 are set by the BIOS of the computer platform 10.

The system image loading module 140 is designed to be capable of being activated in response to an event of the primary operating system loading channel failure flag 112 being set to [TRUE] value (i.e., indicating a failure to the primary operating system code storage area 21) to thereupon perform a system image loading procedure to load a system image from a system image source device 30 (such as a remote hard disk drive) to the primary operating system code storage area 21. Moreover, the system image loading module 140 is further capable of being activated in response to an event of the backup operating system loading channel failure flag 113 being set to [TRUE] value (i.e., indicating a failure to the backup operating system code storage area 22) to thereupon perform a system image loading procedure to load a system image from a system image source device 30 to the backup operating system code storage area 22.

The alarming module 150 is designed to be capable of being activated in response to an event of the primary operating system loading channel failure flag 112 and the backup operating system loading channel failure flag 113 being both set to [TRUE] value (i.e., indicating that a failure occurs to both the primary operating system code storage area 21 and the backup operating system code storage area 22) to thereupon generate a human-perceivable alarming message 301, such as a text message displayed on the monitor screen 11 of the computer platform 10, for the purpose of alerting the network system management personnel to take necessary maintenance tasks on the computer platform 10.

The following is a detailed description of a practical example of the application of the computer platform embedded operating system backup switching handling system of the invention 100 during actual operation.

Referring to FIG. 1, in actual operation, the user can initially embed an operating system in two duplicate copies respectively into the primary operating system code storage area 21 and the backup operating system code storage area 22. At each startup of the computer platform 10 (i.e., each time a startup event 201 occurs on the computer platform 10), it will activate the startup control module 110 to respond by booting the computer platform 10 with the operating system code stored in the primary operating system code storage area 21. If the booting is successful, it will cause the operating system health inspection module 120 integrated in the operating system code to be executed and thereby inspect whether the loaded operating system code can operate normally. If YES, the operating system health inspection module 120 will set the operating system health status flag 111 to a normal operation indicating value.

Afterwards, when the user restarts the computer platform 10 (i.e., initiates another startup event 201 on the computer platform 10), the startup control module 110 will respond by first checking the current setting of the operating system health status flag 111. Since the operating system health status flag 111 is currently set to a normal operation indicating value, it will cause the startup control module 110 to respond by issuing a primary operating system loading enable message to the operating system loading channel switching module 130, thereby activating the operating system loading channel switching module 130 to respond by loading the operating system code stored in the primary operating system code storage area 21 of the non-volatile memory unit 20 to boot the computer platform 10. After the startup control module 110 checks the operating system health status flag 111, it will reset the operating system health status flag 111 to an abnormal operation indicating value before transferring the control to the operating system.

If the loading of the operating system code is successful, the operating system health inspection module 120 is activated to check whether the loaded operating system code is able to operate normally. If YES, the operating system health inspection module 120 capable of setting the operating system health status flag 111 from an normal operation indicating value (i.e., FALSE value) to a normal operation indicating value (i.e., TRUE value), where the normal operation indicating value can be used by the startup control module 110 in the next startup procedure to judge whether the previous startup of the computer platform 10 was successful. If the current startup procedure is successful, then the next startup procedure will not perform a loading channel switching action.

On the other hand, if the loading of the operating system code from the primary operating system code storage area 21 is a failure (i.e., the operating system code stored in the primary operating system code storage area 21 is corrupted), then since the operating system health inspection module 120 embedded in the operating system code will not be activated to execute, it will cause the operating system health status flag 111 to remain at the initially-set abnormal operation indicating value (i.e., FALSE value). Consequently, at the next startup of the computer platform 10, the startup control module 110 will accordingly perform a loading channel switching action.

Since at this time the operating system health status flag 111 is set to [FALSE] value, the startup control module 110 will respond to this condition by issuing an operating system loading channel switching enable message to the operating system loading channel switching module 130, causing the operating system loading channel switching module 130 to respond by switching the current loading channel from the primary operating system code storage area 21 to the backup operating system code storage area 22; and meanwhile, the startup control module 110 sets the primary operating system loading channel failure flag 112 to [TRUE] value. This switching action allows the startup control module 110 to perform a booting procedure with the operating system code stored in the backup operating system code storage area 22. Under this condition, since a failure occurs to the primary operating system code storage area 21 and causes the primary operating system loading channel failure flag 112 to be set to [TRUE] value, the system image loading module 140 will be activated after the operating system is successfully loaded to issue a system image downloading enable message to a system image source device 30, such as a remote hard disk drive, to activate the system image source device 30 to download a copy of system image (i.e., the system image of the operating system) to the primary operating system code storage area 21, to thereby recover the corrupted operating system code in the primary operating system code storage area 21.

If a failure also occurs to the backup operating system code storage area 22 such that the booting of the computer platform 10 is unsuccessful, it will cause the startup control module 110 to set the backup operating system loading channel failure flag 113 to [TRUE] value. In the even that both the primary operating system loading channel failure flag 112 and the backup operating system loading channel failure flag 113 are set to [TRUE] values, it indicates that both the primary copy and backup copy of the operating system stored in the primary operating system code storage area 21 and the backup operating system code storage area 22 are corrupted. In this case, the alarming module 150 is activated to generate a human-perceivable alarming message 301, such as a text message displayed on the monitor screen 11 of the computer platform 10, for the purpose of alerting the network system management personnel to take necessary maintenance tasks on the computer platform 10.

In conclusion, the invention provides a computer platform embedded operating system backup switching handling method and system which is designed for use with a computer platform for providing an embedded operating system backup switching handling function, which is characterized by the provision of an operating system health status flag for indicating whether the primary copy of embedded operating system code has been previously successfully loaded, such that the next time the computer platform is started, the operating system health status flag can be checked to see if the primary copy of embedded operating system code is corrupted; if YES, the booting of the computer platform is switched to use the backup copy of the embedded operating system code. This feature allows the computer platform to more quickly judge whether the embedded operating system code is corrupted, without having to use the more time-wasting checksum method, so that the booting of the computer platform can be more efficiently carried out. The invention is therefore more advantageous to use than the prior art.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A computer platform embedded operating system backup switching handling method for use on a computer platform of the type having a non-volatile memory unit which is partitioned into at least two operating system code storage areas, including a primary operating system code storage area and a backup operating system code storage area for storing at least two copies of an operating system, for the purpose of providing the computer platform with an embedded operating system backup switching handling function;
the computer platform embedded operating system backup switching handling method comprising:
in the event of the operating system code stored in the primary operating system code storage area is successfully loaded into the computer platform, responding by inspecting whether the loaded operating system code can operate normally; if YES, setting an operating system health status flag to a normal operation indicating value;
responding to each startup event on the computer platform by checking the current setting of the operating system health status flag; if the operating system health status flag is currently set to a normal operation indicating value, then issuing a primary operating system code loading enable message, and setting the operating system health status flag to an normal operation indicating value; whereas if currently set to a abnormal operation indicating value, issuing an operating system loading channel switching enable message; and
responding to the operating system loading channel switching enable message by switching the current operating system loading channel from the primary operating system code storage area to the backup operating system code storage area to thereby allow the computer platform to perform a booting procedure with the operating system code stored in the backup operating system code storage area; and further setting the primary operating system loading channel failure flag to true value, and in the event of a failure to the backup operating system code storage area, setting the backup operating system loading channel failure flag to true value.

2. The computer platform embedded operating system backup switching handling method of claim 1, wherein the non-volatile memory unit a flash memory unit.

3. The computer platform embedded operating system backup switching handling method of claim 1, further comprising:
a step of responding to an event of the primary operating system loading channel failure flag being set to true value by performing a system image loading procedure to load a system image to the primary operating system code storage area.

4. The computer platform embedded operating system backup switching handling method of claim 3, further comprising:
a step of responding to an event of the backup operating system loading channel failure flag being set to true value by performing a system image loading procedure to load a system image to the backup operating system code storage area.

5. The computer platform embedded operating system backup switching handling method of claim 1, further comprising:
a step of responding to an event of the primary operating system loading channel failure flag and the backup operating system loading channel failure flag being both set to true values by generating a human-perceivable alarming message.

6. A computer platform embedded operating system backup switching handling system for use with a computer platform of the type having a non-volatile memory unit which is partitioned into at least two operating system code storage areas, including a primary operating system code storage area and a backup operating system code storage area for storing at least two copies of an operating system, for the purpose of providing the computer platform with an embedded operating system backup switching handling function;
the computer platform embedded operating system backup switching handling system comprising:
a startup control module, which is capable of responding to each startup event on the computer platform to perform a startup control procedure, and which is provided with an operating system health status flag, a primary operating system loading channel failure flag, and a backup operating system loading channel failure flag;
an operating system health inspection module, which is integrated to the code of the operating system of the computer platform, and which is capable of being activated in response to each successful booting of the computer platform with the operating system code stored in the primary operating system code storage area to check whether the loaded operating system code is able to operate normally; and if YES, capable of setting the operating system health status flag to a normal operation indicating value, where the normal operation indicating value is used by the startup control module to judge whether the previous startup of the computer platform was successful; and wherein after the startup control module judges that the operating system health status flag is set at normal operation indicating value, the startup control module resets the operating system health status flag to an abnormal operation indicating value, such that at the next startup of the computer platform, if the operating system health status flag is set at abnormal operation indicating value, the startup control module issues an operating system loading channel switching enable message; and
an operating system loading channel switching module, which is capable of responding to the operating system loading channel switching enable message from the startup control module by switching the current operating system loading channel from the primary operating system code storage area to the backup operating system code storage area to thereby allow the startup control module to perform a backup operating system code loading procedure; and which is further capable of setting the primary operating system loading channel failure flag to true value, and in the event of a failure to the backup operating system code storage area, setting the backup operating system loading channel failure flag to true value.

7. The computer platform embedded operating system backup switching handling system of claim 6, wherein the non-volatile memory unit is a flash memory unit.

8. The computer platform embedded operating system backup switching handling system of claim 6, wherein the operating system health inspection module sets the operating system health status flag at a temporal point prior to the handover of system control to the operating system.

9. The computer platform embedded operating system backup switching handling system of claim 6, further comprising:
a system image loading module, which is capable of being activated in response to an event of the primary operating system loading channel failure flag being set to true value indicating a failure to the primary operating system code storage area to thereupon perform a system image loading procedure to load a system image from a system image source device to the primary operating system code storage area.

10. The computer platform embedded operating system backup switching handling system of claim 9, wherein the system image loading module is further capable of being activated in response to an event of the backup operating system loading channel failure flag being set to true value indicating a failure to the backup operating system code storage area to thereupon perform a system image loading procedure to load a system image from a system image source device to the backup operating system code storage area.

11. The computer platform embedded operating system backup switching handling system of claim 6, further comprising:
an alarming module, which is capable of being activated in response to an event of the primary operating system loading channel failure flag and the backup operating system loading channel failure flag being both set to true values to thereupon generate a human-perceivable alarming message.
